(19) United States
(12) Patent Application Publication
(10) Pub. No.: US 2011/0127857 A1
(43) Pub. Date: Jun. 2, 2011

(54) Magnetic motor with embedded honeycombed mounted gate means

(76) Inventor: James David Kundrat, Silver Spring, MD (US)

(21) Appl. No.: 12/592,517

(22) Filed: Nov. 27, 2009

(51) Int. Cl. H02K 7/075; H02N 11/00

(52) U.S. Cl. 310/24; 415/916

(57) ABSTRACT

A magnetic motor utilizing opposed pairs of permanent magnets as a magnetic power source are arranged with their like poles adjacent to each other. An embedded honeycombed mounted gate means is provided between each pair to repel and impart a driving force through a motor linkage mechanism. The gate means is a multilayer sandwich having electromagnets therein to provide an electromagnetic field controlling the alignment of electromagnetic shielding wafer embedded in a honeycombed which is embedded in an conductive jellylike material within the gate means. Also the gate means is embedded in an conductive jellylike material and if desired the motor could be embedded in a jellylike material with openings. Separate power supply means operates the embedded honeycombed gate means.

### BACKGROUND OF THE INVENTION

The invention pertains to magnetic motors which include permanent magnets as part of the power source. An example of a prior art device of similar character is shown in U.S. Pat. No. 3,703,653 issued Nov. 21, 1972 and entitled “Reciprocating Motor With Motion Conversion Means”. This arrangement provides electro-mechanical shiftable means selectively inserted between pairs of permanent magnets with their like poles adjacent one another so as to alter the magnetic field between the magnets, thereby allowing the magnets to move toward one another when the shiftable means is inserted.

### SUMMERY OF THE INVENTION

The present invention relates to a magnetic motor having pairs of permanent magnets which are arranged with their like poles adjacent each other. A wafer embedded honeycombed, conductive jellylike mounted gate means is disposed between each pair of magnets to control the passage of magnetic flux lines between the magnets to cause like poles of each pair to repel and impart a driving force through a motor linkage mechanism.

The motor being of the reciprocating variety. The gate means is controlled by a relatively low voltage means and comprises a multilayer sandwich formed by an array of separator layers spaced apart by a housing and with each separator layer having electromagnets provided formed on their inner surfaces. The electromagnets provided with electrical conductors extending through a housing layer surrounding the sandwich. The sandwich further includes a conductive jellylike material placed in the gap between the electromagnets. Electromagnetic shielding wafer each with one of several layers exhibiting paramagnetic properties are embedded in between the pousness of holes of inner honeycombed in the shape of flat wafers embedded in the conductive jellylike material. Thereby said wafers are suspended in both said materials. In the presence of an electromagnetic field, one orientation of the wafers is formed and in the absence of an electromagnetic field another orientation accurs. One orientation of the wafers block the magnetic flux lines, while in another orientation passage of the flux lines thru the gate is permitted. According selective repulsion of the magnets is controlled by selective orientation of the wafers.

### BRIEF DESCRIPTION OF THE DRAWINGS

FIG. 1 is a schematic section of the reciprocating embodiment of the motor taken along the direction of line 15-15 of FIG. 2;

FIG. 2 is a schematic view of the reciprocating embodiment of the motor;

FIGS. 3A and 3C are the sectional views of the gate member of the motor;

FIGS. 3B and 3D are the schematic section views of the gate member of the motor taken along the direction of line 36-36 of FIGS. 3A and 3C;

FIG. 4 is the sectional view of one of the shielding wafers;

FIG. 5 is the block diagram of the electrical and pulse system for the motor;

FIG. 6 is a schematic block diagram of the electrical and distributor like system for the motor;

### DESCRIPTION OF THE PREFERRED EMBODIMENTS

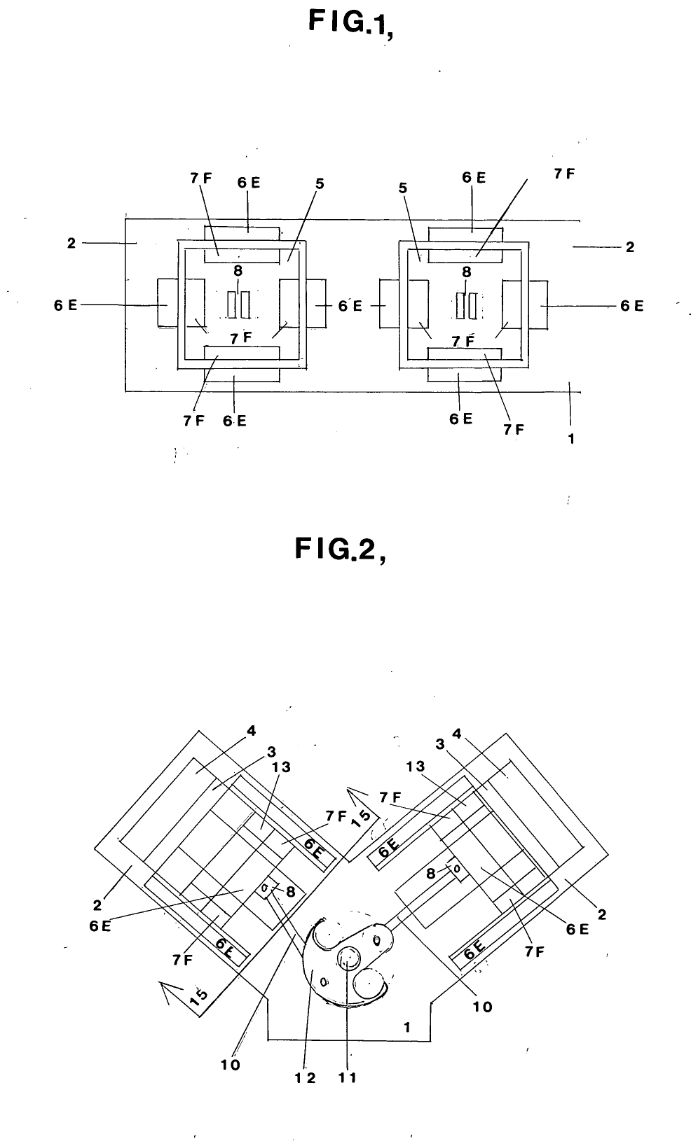

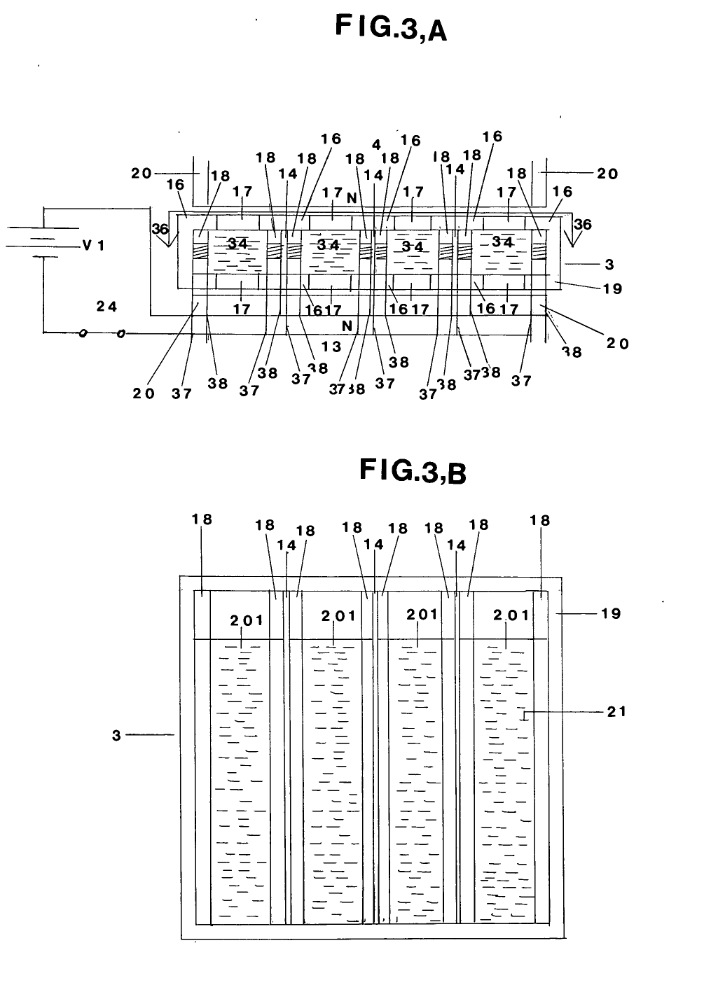

FIG. 1 is a schematic view of the reciprocating embodiment in the direction of line 15-15 of FIG. 2, with elements 10,11 and 12 omitted for clairty.

FIG. 2 is a schematic side view of the reciprocating embodiment of the motor.

Housing 1 functions as a “stator” member 2 formed of Ni—Zn and or plastics and contains gates 3, stator magnets 4, guide members formed as gaps. For each reciprocating member 5 theirs 8 magnets per said member. FIG. 1, 6E and 7F. Permanent magnets 6E extend axially the travelling distance of reciprocable members 5 plus the length of member 5. Recipricating member 5 has magnets 7F and stator 2 housing 5, has magnets 6E as a guide means thereby suspend said members. Strategegecly placed within the gap between housing 1 and reciprocating member's is jellylike material such as silicon. Clevis arms 8 are secured to members 9 and contain pivitol pin aperrtures to pivotally connect crankarms 10 to common crankshaft 11 via eccentric crank portion 12. Each pair of magnets 4 and 13 are arranged with their like poles adjacent one another. As will be understood magnets 13 are each secured to one end of a reciprocable member 5 opposite the end having clevis arms secured thereto. Magnets 13 are formed to present a square “working” face on one end each reciprocable member 5.

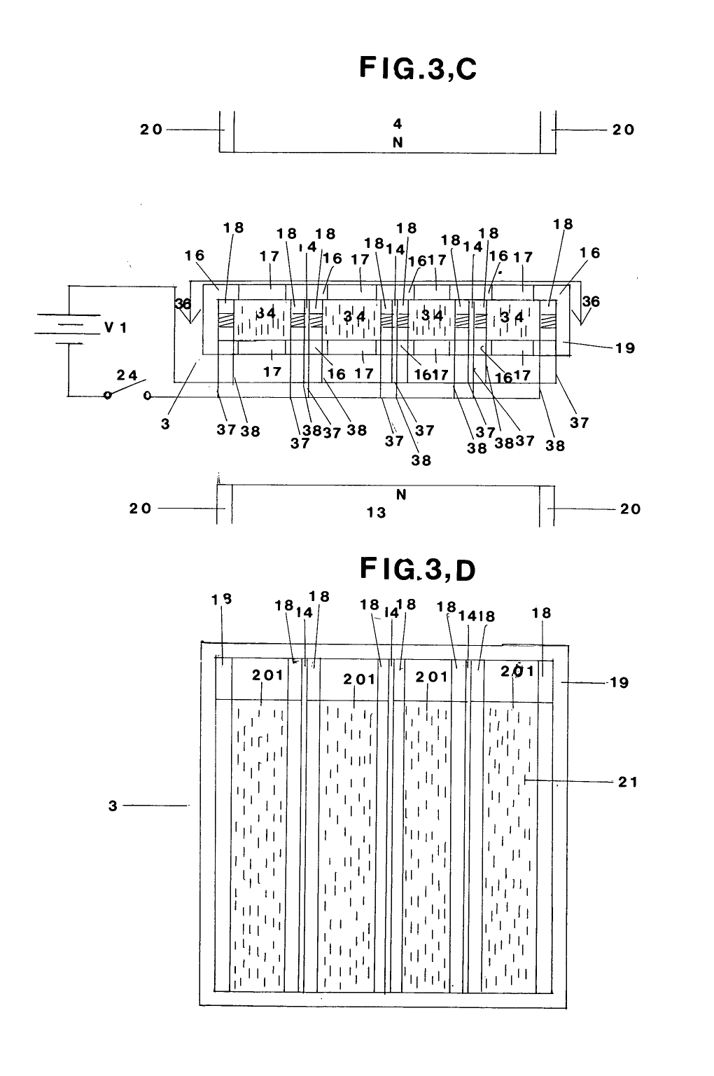

FIGS. 3A and 3C each show a sectional view of the embedded honeycombed and conductive jellylike gate member 3 which is mounted between the like poles of two adjacent magnets 4,13 of a magnetic motor. Honeycombed and jellylike gate member 3 is a multilayer sandwich having several thin separator layers 14. Each separator layer 14 is spaced from the outher and is formed of electromagnetic shielding material such as Ni—Zn alloy or the like and is generally formed as a flat, rectangular substrate. Spacer layers 16 and 17 are flat, rectangular, and are mounted between each of the separator layers 14 at opposite ends thereof and run the length of each separator layer 14 to formed an open-ended box-like structure.

Spacer layers 17 are formed of an electromagnetic permeable material such as plastics (e.g. polethlene terephalate, acrylic resins polyethlene, polyvinloride etc.) or inorganic materials can be used such as SiO, or organic materials such as polymides, polyamides, polyfloroethylene when hardend or the like. Each electromagnet has a coil winding 18 shown with hacked lines of a sutibul material. Each coil winding may also be formed of a photorefractive material such as barium titanate. Gallium aluminum arsenide alloys, and gallium arsenide. Electromagnets 18 are provided with an electrical conductor 37,38 extending through a housing 19. Housing 19 is an external box-like structure that surrounds the inner 14,18,21,34,201 parts and a top and bottom electromagnetic shielding portions 16 and electromagnetic permeable portions 17. Portions 16 are formed of electromagnetic shielding material such as Ni—Zn alloy or the like and portions 17 are formed of electromagnetic permeable plastics or the like. Portions 16 and 17 run the length of the separator layers 14 forming the top and bottom of the external box-like housing structure 19.

The layers of honeycombed 201 host not shown and conductive jellylike host material 34 as shown in FIGS. 3A,3C,3B and 3D have their thickness exagerated for purpose of clarity and better illustration. Number 35 is omitted for better clarity as understood.

Flat electromagnetic shielding wafer 21 guest are embedded in between the porusnes of the holes of the honeycombed 201 host which is formed of aluminum or the like and the shielding wafers are also embedded in conductive jellylike silicon material host layer 34 and held in a predetermined position by said materials 34,201 as shown in FIGS. 3C and 3D. Each magnet 4 and 13 is incased in a magnetic impermeable housing 20 open at one end so as to direct the magnetic flux lines into and through the housing 19 containing the gate means.

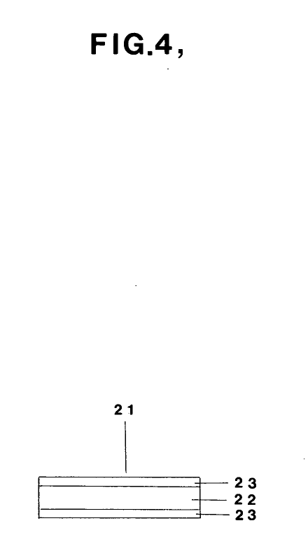

Attention is directed to FIG. 4 which shows a sectional view of a shielding wafer. FIG. 4 the shielding wafer structure is longitudinal section thru a generally rectanular layered “tablet”. It should be noted however that outher appropriate configurations may be used. Wafer 21 is shown to have a thin paramagnetic layer 22 sandwiched between two thin electromagnetic shielding layer 23. Layer 22 then has both its ends and sides exposed about the peripery of the sandwich forming the layered “tablet”. As shown in FIG. 4 layer 22 may be thicker then layers 23 if desired. Layer 22 may be formed of a paramagnetic material such as a paramagnetic salt crystal which can be grown to the appropriate shape. Some examples of paramagnetic salt crystals that may be utilized are: dyrsposium ethyl sulfate, gadolinium sulfate, cerium fluoride, cerium ethy sulfate, chromium potassium alum, iron ammonium, alum mixture, cesium titanium alum, copper potassium sulfate or gadolinium nitrobenezene sulfonate. Also layer 22 may, if desired, be formed of a ferromagnetic material in a binder. Electromagnetic or magnetic shielding layers 23 are respectively formed on outer surfaces of layer 22 and are farmed of stainless steel or the like.

The operation of the honeycombed gate means 3 will now be described. FIGS. 3A and 3B shows via switch 24 a voltage potential V1 frequency exceeding the inharent strength of the power source magnets of the motor being applied across electromagnets 18 exciting field and causing each embedded flat wafer guest 22 to relign within the aluminum honeycombed host 201 and conductive jellylike material host 34 parallel to the direction of the applied field across electromagnets 18. As a result of this alignment transverse to the magnetic flux lines each flat wafer 21 receives and blocks a portion of the magnetic field between adjacent magnets 4,13. All such wafers, acting together, forme a complete barrier and prevent repelling movement of the magnets. FIGS. 3C and 3D shows via switch 24 the voltage potential V1 withdrawn from electromagnets 18 and allowing the orientation of the host 201 and resilience of the conductive jellylike host material 34 to return each embedded flat wafer 21 to its original orientation in parrallel with magnets 13 and via layer 22 FIG. 4. In this position the honeycombed gate 3 is open allowing the magnetic field to flow between the magnets. As can be seen the flux path through the gate structure extends from each magnet 4,13 through electromagnetic permeable portions 16 electro and electromagnetic, magnetic permeable aluminum honeycombed host 201 and conductive jellylike host material 34.

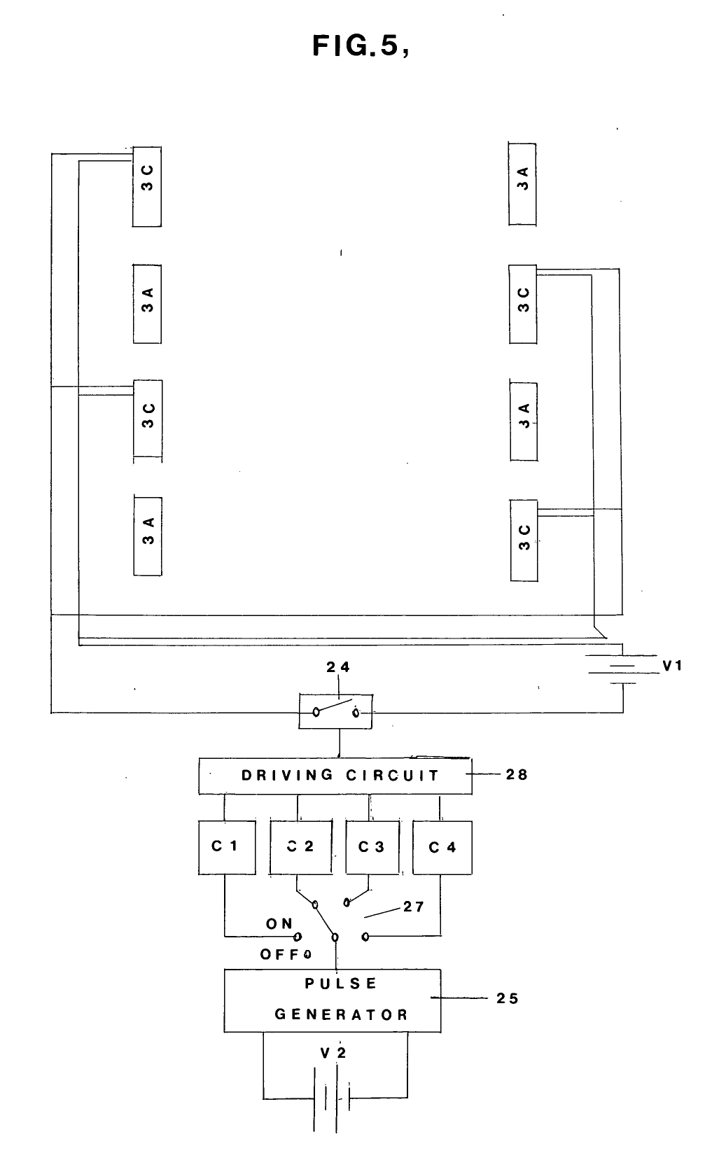

FIG. 5 shows a block diagram of a preferred electrical and pulse system for controlling a magnetic motor utilizing the gate of FIGS. 3A,3B FIGS. 3C,3D. A friction part not shown is provided for reciprocating motor and as shown on, off switch is provided. Voltage potential V1 is connected to each gate member 3C by switch 24 pulse generator 25 generates high speed pulses which are then carried through rotory gating switch 27 in rotory steps between the four gating circuit C1 through C4. Any suitable number of gating circuits may be utilized. A suitable gating circuit would be a monostable multivibrator. Gating circuit C1 divides the generated pulse into time intervals of 0.1 second and gating circuit C2 divides into time intervals 0.1 second and gating circuit C3 divides into time intervals 0.01 second and gating circuit C4 divides into time intervals of 0.001 second etc. The high speed intervals are then received by driving circuit 28. Driving circuit 28 then drives the intervals to switch 24 which controls the application and removal of voltage potential V1 to each gate member 3C. Voltage potential V2 is connected to pulse generator 25.

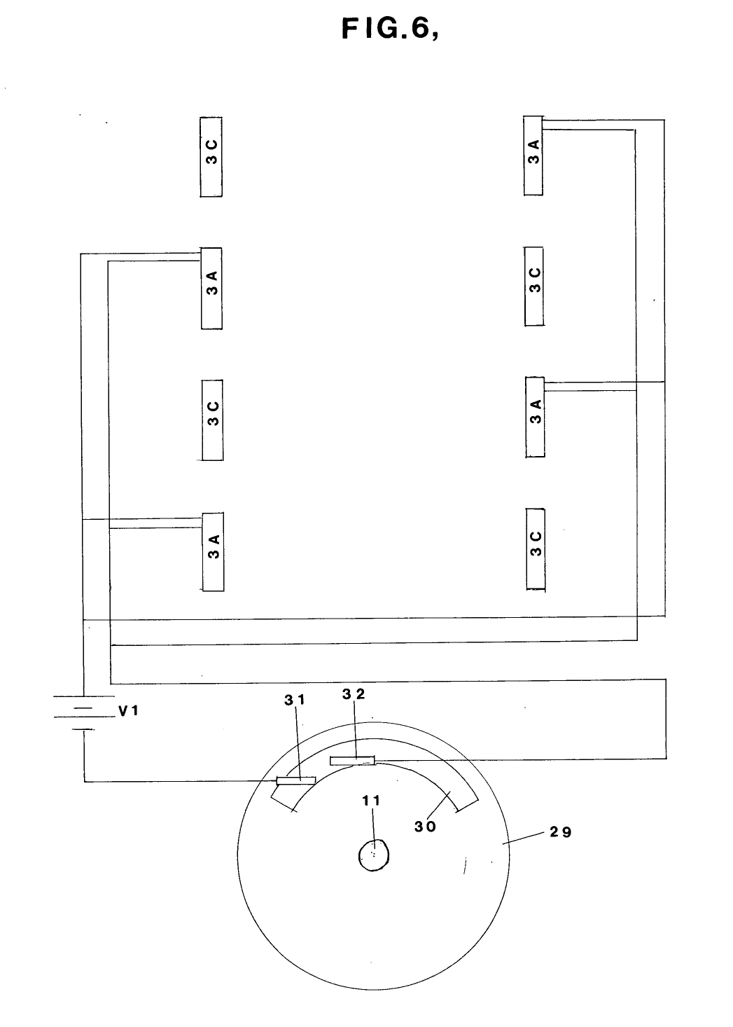

FIG. 6 shows the same block diagram of the gate members found in FIG. 5 however voltage potential V1 is connected to each gate member 3A via distributor like system 29. Distributor 29 being a flat disc which is attached to crankshaft 11 FIG. 2 within a gap provided by a housing block. Distributor 29 having portion 30 formed on one side of disc 29 and being formed of a conductive material such as copper or the like. The size has been exagerated for clarity.

Conductive slide contacts 31 and 32 are affixed within the housing block FIG. 2. The rotary contact causes a closed circuit as shown. Thereby controlling the application and removal of voltage potential V1 to each gate member 3A.

The operation of the motor of FIGS. 1 and 2 will now be described with the understanding that the circuit arrangements of FIGS. 5 and 6 may be adopted to control the operation thereof.

With magnets 13 and attached reciprocable members 5 position as shown in FIG. 2 and gates 3 closed as shown in FIGS. 3A and 3B magnets 13 are attracted to shielding wafers 21 via this orientation [FIG. 4]. When magnets 13 reach the limit of their travel and are close proximity to gates 3 the voltage potential V1 is withdrawn and gates 3 are opened as shown via the resilience of conductive jellylike host in FIGS. 3C and 3D. Magnetic repulsion between magnets 13 and 4 through the open gates 3 causes magnets 13 and attached reciprocable members 5 to begin movement away from gates 3 and magnets 4.

When magnets 13 and attached reciprocable members 5 reach the limit of their travel away from gates 3 the voltage potential V1 is applied to close gates 3 as shown in FIGS. 3A and 3B and attraction of magnets 13 and attached reciprocable members 5 to shielding wafers 21 begins travel of these members toward the gates 3. This cycle is repeated again and again so imparts a rotary force to crankshaft 11.

In addition to the magnetic propultion system the eccentric crank portion is positioned in the linkage mechanism so as to have its rotory inertia act as a positive force in unison with and complementary to the magnetic system.

It will be seen that on the use of an effective motor utilizing opposed permanent magnets a permanently interposed gate means between the magnets is provided requiring for its control only the selective application of an electric input and so improving the overall efficiency of the motor and its operation.

Large number 201 is for better clarity and understanding.

I claim:

1. A, magnetic motor comprising pairs of permanent magnets, one magnet of each pair being stationary and the other magnet of each pair being shiftable relative thereto, the magnets of each pair being arranged with their like poles adjacent one another to thereby normally place them in a repulse state, plurality of electromagnetic shielding elements mounted in an, honeycombed, jellylike material means, and means to selectively control the orientation of electromagnetic shielding elements from a aligned closed position from between the magnets of each pair to a aligned open position directly between the magnets of each pair to repulse each other and then move toward each other, means connecting the shiftable magnets of each pair to a common drive shaft.

2. A, magnetic motor set forth in claim 1 further characterized in that said means to selectively control the orientation of said electromagnetic shielding elements within the jellylike material is an electric input selectively applied through the electromagnets.

3. A, magnetic motor set forth in claim 1 with means for selectively applying said electric input comprising a main circuit having a pulse generator, gating circuits, driving circuit, and distributor.

4. A magnetic motor set forth in claim 1 wherein said jellylike material is part of a multilayer sandwich elements extending between and parallel to the magnetic fields of element extending between and parallel to the magnetic fields of each pair of magnets.

5. A magnetic motor set forth in claim 4 wherein said multilayer sandwich includes electric leads formed of a photorefractive material.
